(19) United States
(12) Patent Application Publication
(10) Pub. No.: US 2015/0112962 A1
(43) Pub. Date: Apr. 23, 2015

(54) SYSTEM AND METHOD FOR LAUNCHING APPLICATIONS ON A USER DEVICE BASED ON THE USER INTENT

(71) Applicant: Doat Media Ltd., Tel Aviv (IL)

(72) Inventors: Joey Joseph Simhon, Ramat-Gan (IL); Amir Taichman, Haifa (IL); Avi Charkam, Givataim (IL)

(73) Assignee: Doat Media Ltd., Tel Aviv (IL)

(21) Appl. No.: 14/583,310

(22) Filed: Dec. 26, 2014

Related U.S. Application Data
(63) Continuation-in-part of application No. 13/712,563, filed on Dec. 12, 2012.
(60) Provisional application No. 61/920,784, filed on Dec. 26, 2013.
(60) Provisional application No. 61/653,562, filed on May 31, 2012.

(51) Int. Cl. G06F 17/30; G06N 7/00

(52) U.S. Cl. CPC G06F 17/30867; G06N 7/005
USPC 707/709

(57) ABSTRACT

A method and system for launching applications on a user device responsive to a user intent are configured. The method includes receiving at least one environmental variable; analyzing the at least one environmental variable to determine the user intent, wherein the user intent represents a current topic of interest of a user of the user device; matching the determined user intent against an applications index to find at least a category of interest that best matches the determined user intent; and selecting an application associated with the matching category of interest; and causing a launch of the selected application on the user device.

### CROSS REFERENCE TO RELATED APPLICATIONS

This application claims the benefit of U.S. provisional patent application No. 61/920,784, filed on Dec. 26, 2013. This application is also a continuation-in-part application of U.S. patent application Ser. No. 13/712,563, filed on Dec. 12, 2012, now pending, which claims the benefit of U.S. provisional patent application No. 61/653,562, filed on May 31, 2012. The contents of the above-referenced applications are incorporated herein by reference.

### TECHNICAL FIELD

The disclosure relates generally to a method for launching applications on a user device, and more specifically to a system and method for executing applications on a user device responsive to at least one environmental variable.

### BACKGROUND

The use of mobile devices and especially smart phones has significantly increased. Such mobile devices have become, in many cases, a primary replacement for other computing devices, allowing access by the mobile devices to data in a variety of application programs. Application programs, also known as applications or Apps, are designed to help a user of a mobile device (typically a smart phone or tablet computer) to perform specific tasks. Applications may be installed on a mobile device or may be accessible and sometimes downloadable from a web source such as, for example, the AppStore®.

Once an application is installed, in order to launch the application on the mobile phone, the user needs to search for the application and tap on the application. Some operating systems allow a user to place certain applications in an easily accessible area to allow the user to easily locate such applications. The applications that can be quickly accessed may be pinned by the user of the devices or selected by the operating system based on the usage of the installed application. Operating systems of mobile devices can also switch between applications running in the background. All of these solutions require the user to proactively select the applications to be launched.

There are some drawbacks with the way that mobile devices' operating systems (e.g., iOS and Android) allow interaction with mobile devices. For example, a user may require the information from a certain application while driving. As such, interacting with the mobile device at that situation is dangerous and/or illegal.

Typical mobile devices are installed with applications (e.g. emails, etc.) that provide an access to, or contain, private and/or confidential information. Consequently, mobile devices have become more sensitive and valuable. To prevent unauthorized users from accessing applications, security measures are usually required, e.g., unlocking a screen using a password. However, once the phone screen is unlocked almost any installed applications can be accessed. As such, a child playing with the mobile device can access an email application, although that the child's intent or interest would be a gaming application. Therefore, another drawback of mobile devices is that users can access applications that are not to their interest.

As an example for another drawback, mobile devices are installed with tens of applications so the user typically is not aware of the application that best serves his/her interest at a current moment.

Therefore, it would be advantageous to provide a solution that overcomes at least the drawbacks noted above by automatically launching at least one application of the current interest of the user.

### SUMMARY

A summary of several example aspects of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all aspects. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain embodiments disclosed herein include a method for launching applications on a user device responsive to a user intent. The method comprises receiving at least one environmental variable; analyzing the at least one environmental variable to determine the user intent, wherein the user intent represents a current topic of interest of a user of the user device; matching the determined user intent against an applications index to find at least a category of interest that best matches the determined user intent; and selecting an application associated with the matching category of interest; and causing a launch of the selected application on the user device.

Certain embodiments disclosed herein include a system for launching applications on a user device responsive to a user intent. The system comprises a processing unit; and a memory connected to the processing unit, the memory containing instructions that when executed by the processing unit, configure the system to: receive at least one environmental variable; analyze the at least one environmental variable to determine the user intent, wherein the user intent represents a current topic of interest of a user of the user device; match the determined user intent against an applications index to find at least a category of interest that best matches the determined user intent; select an application associated with the matching category of interest; and cause a launch of the selected application on the user device.

Certain embodiments disclosed herein include a user device for launching applications responsive to a user intent. The user device comprises a plurality of sensors communicatively connected to the user device, wherein the sensors are configured to collect at least one environmental variable; a processing unit; and a memory connected to the processing unit, the memory containing instructions that, when executed by the processing unit, configure the user device to: receive at least one environmental variable; analyze the at least one environmental variable to determine the user intent, wherein the user intent represents a current topic of interest of a user of the user device; match the determined user intent against an applications index to find at least a category of interest that best matches the determined user intent; select an application associated with the matching category of interest; and launch the selected application.

### BRIEF DESCRIPTION OF THE DRAWINGS

The subject matter disclosed herein is particularly pointed out and distinctly claimed in the claims at the conclusion of the specification. The foregoing and other objects, features and advantages of the invention will be apparent from the following detailed description taken in conjunction with the accompanying drawings.

FIG. 1 is a schematic diagram of the operation of a network system utilized to describe the various disclosed embodiments.

FIG. 2 is a flowchart describing a method for launching an application based on the user intent according to an embodiment.

FIG. 3 is a flowchart describing a method for generating an applications index the according to an embodiment.

FIG. 4 is a flowchart illustrating detection of the user intent according to an embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

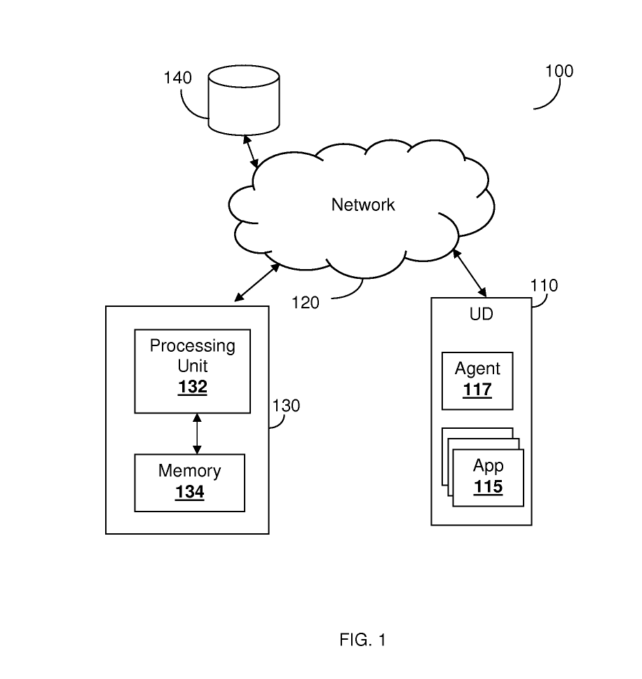

FIG. 1 depicts an exemplary and non-limiting schematic diagram of a network system 100 utilized for describing certain embodiments disclosed herein. A user device 110 is communicatively connected to a network 120. The user device 110 may be, but is not limited to, a personal computer (PC), a laptop, a tablet computer, a mobile phone, a smart phone, a wearable computing device, a smart television, a portable device having a processing unit integrated therein, and the like. The network 120 may be, but is not limited to, a local area network (LAN), a wide area network (WAN), a metro area network (MAN), the world wide web (WWW), the Internet, a wired network, a wireless network, and the like, as well as any combination thereof.

A user device 110 may be equipped with a plurality of sensors (not shown) utilized to collect one or more environmental variables. The sensors may be, for example but are not limited to, a camera, a web camera, a microphone, a global positioning system (GPS), a speech recognizer, a temperature meter, a motion sensor, and the like.

Each user device 110 is further configured to allow access to a plurality of applications 115 (collectively referred hereinafter as applications 115 or individually as an application 115, merely for simplicity purposes). An application 115 may include a native application and/or a virtual application. A native application (or app) is installed and executed on the user device 110. A virtual application (app) is executed on a server and only relevant content is rendered and sent to the user device 110. That is, the virtual application typically runs within a browser embedded in another program, thereby permitting users to utilize virtual versions of the application without any download to the user device 110 directly.

The network system 100 further includes a server 130 and a database 140 for storing information related to the user device 110 and to the applications installed therein. It should be noted that only one user device 110 is illustrated in FIG. 1, merely for simplicity purposes.

According to the disclosed embodiments, the server 130 is configured to receive a plurality of environmental variables. Such variables may include, but are not limited to, search history, time of day, social friends, location, motion information, weather information, sounds, images, queries previously provided by the user, user's gesture, a voice command, sentiment inputs received from the user, and more. The environmental variables may be received from the database 140 and/or from the user device 110. For example, location information can be received by a GPS in the user device 110, while social friends may be received from a database 140 of a social media website. In addition, personal variables, such as a user profile, demographic information related to the user, and so on, can be retrieved by the server 130.

The server 130 is configured to determine the user intent (or user search intent) based on the received variables. The user intent represents a topic of interest of a user of the user device 110 at a certain time. With this aim, according to an exemplary embodiment, the server 130 is configured to analyze one, some, or all of the received variables to derive at least one category of interest. The correlation is performed based on the context of the analyzed variables.

Once the intent is determined, the server 130 is configured to select an application 115 accessible through a user device 110 that is the most appropriate to fulfill the user intent. The selection is based on the applications' 115 categories as discussed herein below. Once the application 115 is selected, the server 130 is configured to cause the user device 110 to launch the application. The launched application may be realized by sending the application name or application identifier ID to an agent 117 or to the operating system of the device 110.

In an embodiment, the server 130 is configured to keep an index of the application(s) 115. The index includes for each application 115 at least its metadata. The metadata includes, for example, the name of the application, the application bundle name, the application description, and the like. The index of application 115 can be generated by the agent 117 and sent to the server 130 or retrieved by the server 130, for example, by querying the user device's 110 operating system.

In an embodiment, the indexed applications 115 can be categorized according to topics of interest, such as “games”, “social”, “finance”, “utilities”, “travel”, and so on. The classification to categories may be performed based on the applications' metadata. For example, the application “Flight Aware” is classified as “Travel.”

As an example for the operation of the server 130, the received environmental variables include GPS coordinates of the current user device's 110 location and a previously submitted query to a search engine was “flight arrivals”. Analysis of the GPS coordinates indicates that the user is now at JFK Airport and, together with the query variable, the user intent is determined to be “flight”, thus the application “Flight Aware” may be launched upon arrival of the user to the terminal.

The server 130 typically includes a processing unit 132 and a memory 134 containing instructions to be executed by the processing unit 132. The processing unit 132 may comprise, or be a component of, a larger processing unit implemented with one or more processors. The one or more processors may be implemented with any combination of general-purpose microprocessors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that can perform calculations or other manipulations of information.

The processing unit 132 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing unit 132, cause the processing unit 132 to perform the various functions described herein.

In one embodiment, the user device 110 is installed with an agent 117 for interacting with the user. The agent 117 may be a dedicated application, script, or any program code stored in the memory 134 of the user device 110 and is executable, for example, by the operating system of the user device 110. The agent 117 may be configured to perform some or all of the processes performed by the server 130 and disclosed herein.

In an embodiment, the agent 117 is configured to index all applications 115 installed in and/or accessible through the user device 110. The index may be saved in the memory 134 of the user device 110 and/or sent to the server 130. The agent 117 may be further configured to collect environmental and/or personal variables and send the collected variables to the server 130. In yet another embodiment, the agent 117 is configured to determine user intent and based thereon launch one of the indexed applications 115. Alternatively, the determined user intent may be sent to the server 110. Thus, the disclosed embodiments can be executed using the agent 117. It should be noted that the agent 117 can launch applications 115, based on the determined intent, when the device 110 is offline, i.e., not connected to the network 120.

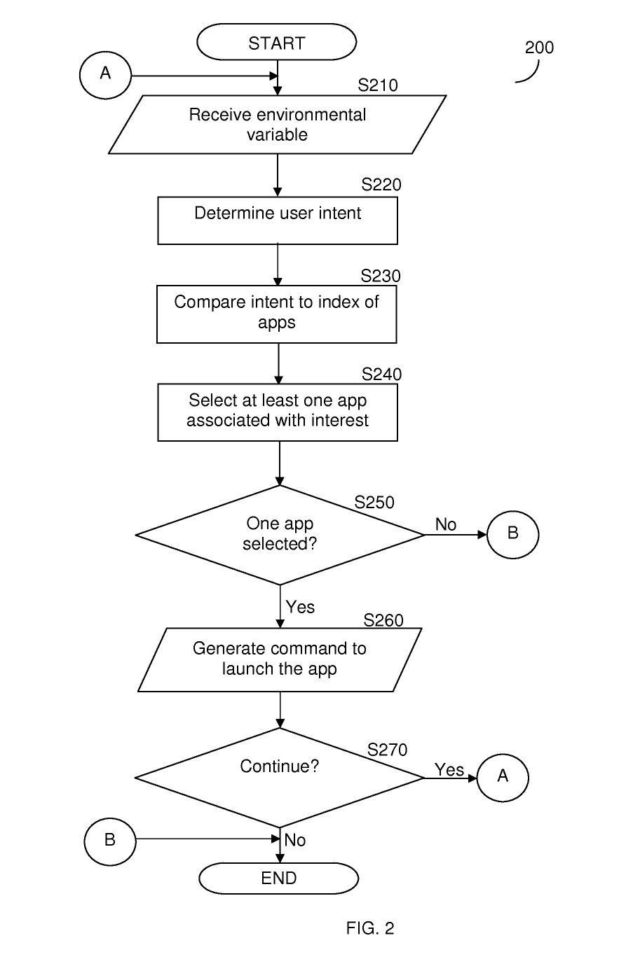

FIG. 2 depicts an exemplary and non-limiting flowchart 200 of a method for launching an application on a user device responsive to the user search intent according to one embodiment.

In S210, at least one environmental variable is received. An environmental variable may be, for example and not by way of limitation, the location of the user device, previously submitted queries, the device rate of motion, time of day, and the like. The environmental variable may be received from a sensor that is part of the user device, a database, or by monitoring the user activity on the user device.

Optionally, one or more personal variables may be also retrieved or received. As mentioned above, such variables may include, but are not limited to, a user profile, demographic information, user's preferences, and so on. Such variables may be retrieved or received from systems and databases that generate and/or maintain the variables.

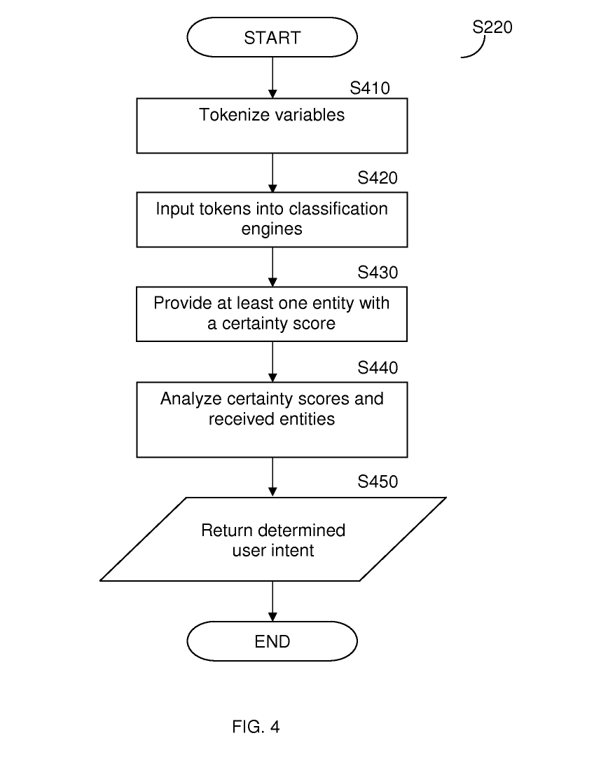

In S220, based on the received variables, the user intent is determined. The intent represents a topic of interest at a current time period. In one embodiment, the user intent is determined by analyzing the received environmental variables. The user intent can also be determined using one or more personal variables that may be correlated with the environmental variables. A non-limiting embodiment for determining the user intent is described in FIG. 4.

For example, if the time is 8am on Monday and the user's device location is the user's home, then the intent may be related to “review news” or “review emails”. If the location changes to away-from-home, and the GPS information indicates the user is driving, the intent may be changed to receiving traffic updates or listening to the user's favorite radio station during the user's commute. As another example, if the device's motion is determined to be at a rate of a person walking, and the location is determined as 5^{th} Avenue in New York City, the user intent may be “shopping.”

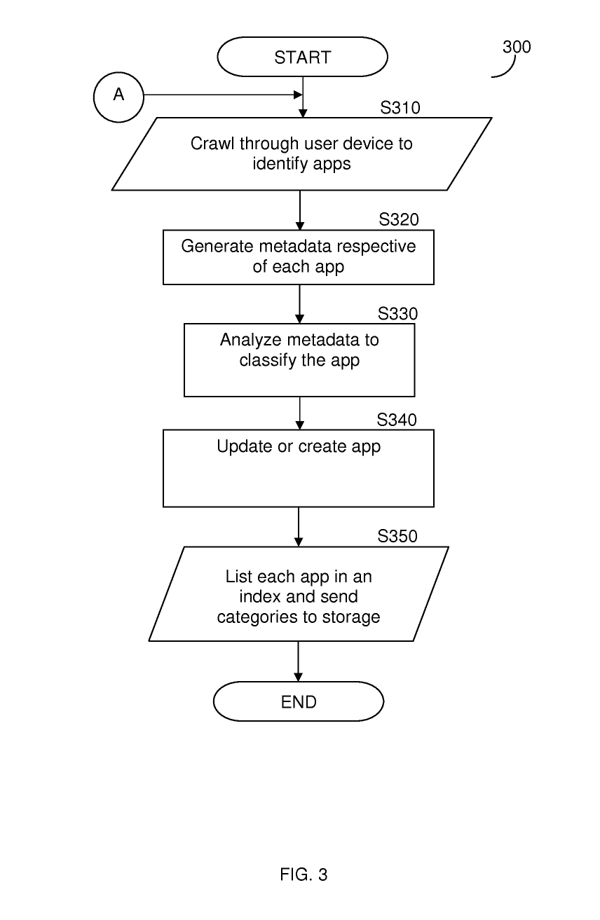

In S230, the determined user intent is compared to an index of applications to find a category of interest matching the intent. The index includes applications installed in the user device and/or accessible through the user device indexed according to their respective metadata. Each indexed application is classified to at least one category of interest. The application indexing process is further described in FIG. 3.

In an embodiment, the category of interest that best matches the user intent is determined. In a non-limiting implementation, textual comparison is performed. For example, a determined intent of “kids games” would best match a category of interest of “games.”

In S240, at least one application associated with the determined category of interest is selected. It should be noted that S250 is performed if there is more than one application associated with the determined category of interest. The selection may be random or based on predefined configuration (e.g., a certain application should be always selected) or an appropriateness score. An appropriateness score indicates how well the application can represent a certain category and may be determined during the indexing process.

In S250, it is checked if one application associated with the determined category of interest is selected, and if so execution continues with S260; otherwise, the execution ends.

In S260, a command to launch the selected application is generated. Such a command may include the ID or name of the selected application and may be provided to the user device's operation system.

In S270, it is checked whether it is necessary to continue the execution of the method, for example, due to changes in at least one of the received variable or reception of new variables. If so, execution continues with S210; otherwise execution terminates.

FIG. 3 is an exemplary and non-limiting flowchart 300 of a method for indexing applications according to one embodiment. The method may be performed by the server 130. In S310, a crawling procedure is performed through a user device to identify applications installed in the user device and/or accessible through the user device. As noted above, each such application may be a native application or a virtual application.

In S320, metadata respective of each identified application is generated. Such metadata may be, for example: the name of the application, the application bundle name, the application description, applications' URL, deep URLs, and so on. Deep URLs are links to content that can be viewed or retrieved through the application. For example, for an application for recipes, the deep URLs may direct to the recipes offered by the application.

In S330, the metadata is analyzed to classify each application to one or more categories of interest. The analysis of the metadata includes, for example, textual analysis of the application's description, the application bundle name, and/or name. The analysis may include querying external databases to determine the category to classify the application.

In S340, an application is updated or otherwise initially created. In S350, each application detected in S310 is listed in an index and the categories that the applications are classified to are sent for storage in a database. The index may also include an appropriateness score indicating how well the application can describe a certain category. In another embodiment, the index includes for each indexed application its associated metadata. The application in the index is identified by, for example, the application ID.

The application index may be saved in the database (e.g., database 140), the server 130, and/or locally in the use device. The index may be updated based on usage of the applications, installation of new applications, or removal of installed applications.

FIG. 4 depicts an exemplary and non-limiting flowchart S220 of a process for determining the user intent according to one embodiment. In S410, the received environmental and/or personal variables containing textual information are tokenized into tokens which may be a word or phrase. It should be noted that variables that do include meaningful textual information are not tokenized, but the entire variable is treated as a token. For example, an environmental variable of a user location in a hospital may be tokenized as “hospital” or “medical”.

In S420, the tokens are input into at least one classification engine. In an embodiment, each engine computes the probability that a token is mapped to at least an entity that the engine is configured with. An entity represents a topic of interest. The probability computation is realized by a certainty score.

The classification engines are configured to handle one or more different topics of interest. In one embodiment, the classification engines are configured to map input tokens to entities. As noted above, entities are objects that can be defined using a set of attributes such as consumer goods, locations, keywords, mobile applications (apps), person names, questions, URLs, and so on. The engines are periodically updated with relevant content and are therefore consistent with the trends related to the respective topics.

According to one embodiment, the probability may be computed based on at least one of: the frequency of appearance of the tokens within entities maintained by the engines, the correlation of the tokens to the entities, the matching between each of the tokens to the entities, and so on.

In S430, at least one entity is provided together with a certainty score by each of the classification engines. As an example, the tokenized query ‘Madonna’ can be mapped to the entities: ‘musician’ and ‘religious figure’. In an embodiment, entities with certainty scores below a predefined threshold are not output by the engines. In S440, at least a statistical analysis, a semantic analysis, or both is performed on at least the certainty scores and entities received from the engines to determine the user intent. In S450, the determined user intent is returned.

For example, environmental variables are received indicating the user is at a sports arena in Newark, New Jersey, and personal variables indicate the user is a Devils hockey fan. These variables may be tokenized as “Newark hockey arena” and “hockey fan” respectively. The tokens are input into a classification engine which computes the probability that the tokens are mapped to the entities “New Jersey Devils” and “New York Rangers”. The entities and probabilities are provided and statistical analysis determines the user intent is “New Jersey Devils” as the probability a hockey fan in Newark is interested in the Devils is higher than the probability the hockey fan is interested in the Rangers. Respective of the determination an ESPN application may be launched to a Devils page in the application when the user is in the sports arena.

The various embodiments may be implemented as hardware, firmware, software, or any combination thereof. Moreover, the software is preferably implemented as an application program tangibly embodied on a program storage unit or tangible computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. All or some of the servers maybe combined into one or more integrated servers. Furthermore, a non-transitory computer readable medium is any computer readable medium except for a transitory propagating signal.

All examples and conditional language recited herein are intended for pedagogical purposes to aid the reader in understanding the principles and the concepts contributed by the inventor to furthering the art, and are to be construed as being without limitation to such specifically recited examples and conditions. Moreover, all statements herein reciting principles, aspects, and embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for launching applications on a user device responsive to a user intent, comprising:
receiving at least one environmental variable;
analyzing the at least one environmental variable to determine the user intent, wherein the user intent represents a current topic of interest of a user of the user device;
matching the determined user intent against an applications index to find at least a category of interest that best matches the determined user intent;
selecting an application associated with the matching category of interest; and
causing a launch of the selected application on the user device.

2. The method of claim 1, further comprising:
receiving at least one personal variable; and
determining the user intent based on the at least one personal variable and the at least one environmental variable.

3. The method of claim 2, wherein the at least one personal variable includes a profile of the user and demographic information related to the user.

4. The method of claim 2, wherein the at least one environmental variable includes any one of: search history, a time of day, a list of social friends as posted on a social web site, location information, motion information, weather information, queries previously submitted by the user, user's detected gesture, a voice command, and a sentiment input.

5. The method of claim 3, wherein the environmental variable is collected by at least one sensor of the user device, wherein the at least one sensor includes any one of: a camera, a web camera, a microphone, a GPS, and a speech recognizer.

6. The method of claim 1, wherein the application index lists at least one of:
native applications installed one the user device, and virtual applications accessible through the user device.

7. The method of claim 6, wherein each application in the application index is associated with at least one category of interest.

8. The method of claim 7, further comprising generating an application index by:
crawling through the user device to identify native applications and virtual applications;
for each identified application:
analyzing metadata associated with the application;
classifying the application to at least one category of the interest based on the identified metadata; and
updating the application index to designate the application and its respective classified category of interest.

9. The method of claim 2, wherein determining the user intent further comprises:
tokenizing each received variable to at least one token;
processing the at least one token by a plurality of classification engines, wherein each engine of the plurality of engines is configured to compute a certainty score that indicates a probability that the at least one token is mapped to at least one entity of interest;
receiving from a set of engines of the plurality of engines at least one entity of interest and computed certainty scores; and
analyzing the received certainty scores and the at least one entity of interest to determine the user intent.

10. The method of claim 9, wherein analyzing the received certainty scores and the at least one entity of interest is performed using at least one of: a statistical analysis, and a semantic analysis.

11. The method of claim 1, wherein selecting the application is performed using any one of: random selection, a predefined configuration, and an appropriateness score.

12. The method of claim 1, wherein causing the launch of the selected application further comprises:
generating an execution command related to the selected application; and
providing the execution command to an operating system of the user device.

13. A non-transitory computer readable medium having stored thereon instructions for causing one or more processing units to execute the method according to claim 1.

14. A system for launching applications on a user device responsive to a user intent, comprising:
a processing unit; and
a memory connected to the processing unit, the memory containing instructions that when executed by the processing unit, configure the system to:
receive at least one environmental variable;
analyze the at least one environmental variable to determine the user intent, wherein the user intent represents a current topic of interest of a user of the user device;
match the determined user intent against an applications index to find at least a category of interest that best matches the determined user intent;
select an application associated with the matching category of interest; and
cause a launch of the selected application on the user device.

15. The system of claim 14, the system is further configure to:
receive at least one personal variable; and
determine the user intent based on the at least one personal variable and the at least one environmental variable.

16. The system of claim 15, wherein the at least one personal variable includes a profile of the user and demographic information related to the user.

17. The system of claim 15, wherein the at least one environmental variable includes any one of: search history, a time of day, a list of social friends as posted on a social web site, location information, motion information, weather information, queries previously submitted by the user, user's detected gesture, a voice command, and a sentiment input.

18. The system of claim 16, wherein the environmental variable is collected by at least one sensor of the user device, wherein the at least one sensor includes any one of: a camera, a web camera, a microphone, a GPS, and a speech recognizer.

19. The system of claim 14, wherein the application index lists at least one of: native applications installed one the user device, and virtual applications accessible through the user device.

20. The system of claim 19, wherein each application in the application index is associated with at least one category of interest.

21. The system of claim 20, wherein the system is further configured to:
crawl through the user device to identify native applications and virtual applications;
for each identified application:
analyze metadata associated with the application;
classify the application to at least one category of the interest based on the identified metadata; and
update the application index to designate the application and its respective classified category of interest.

22. The system of claim 15, wherein the system is further configured to determine the user intent is further configured to:
tokenize each received variable to at least one token;
process the at least one token by a plurality of classification engines, wherein each engine of the plurality of engines is configured to compute a certainty score that indicates a probability that the at least one token is mapped to at least one entity of interest;
receive from a set of engines of the plurality of engines at least one entity of interest and computed certainty scores; and
analyze the received certainty scores and the at least one entity of interest to determine the user intent.

23. The system of claim 22, wherein the system is further configure to analyze the received certainty scores and the at least one entity of interest using at least one of: a statistical analysis, and a semantic analysis.

24. The system of claim 14, wherein the selection of the application is performed using any one of: random selection, a predefined configuration, and an appropriateness score.

25. The system of claim 14, wherein the system is configured to cause the launch of the selected application is further configured to:
generate an execution command related to the selected application; and
provide the execution command to an operating system of the user device.

26. A user device for launching applications responsive to a user intent, comprising:
a plurality of sensors communicatively connected to the user device, wherein the sensors are configured to collect at least one environmental variable;
a processing unit; and
a memory connected to the processing unit, the memory containing instructions that when executed by the processing unit, configure the user device to:
receive the at least one environmental variable;
analyze the at least one environmental variable to determine the user intent, wherein the user intent represents a current topic of interest of a user of the user device;
match the determined user intent against an applications index to find at least a category of interest that best matches the determined user intent;
select an application associated with the matching category of interest; and
launch the selected application.

27. The user device of claim 26, further configured to:
receive at least one personal variable; and
determine the user intent based on the at least one personal variable and the at least one environmental variable.
